(19) United States
(12) Patent Application Publication
(10) Pub. No.: US 2007/0169162 A1
(43) Pub. Date: Jul. 19, 2007

(54) Hierarchical communications network with upstream signal controllable from head end

(76) Inventor: Srinivas Kola, Saratoga, CA (US)

Correspondence Address: Clifton L. Anderson;C9 Networks, Suite 205, 341 Cobalt Way, Sunnyvale, CA, 95085, US

(21) Appl. No.: 11/334,621

(22) Filed: Jan. 18, 2006

(51) Int. Cl. H04N 7/173

(52) U.S. Cl. 725/117; 725/105; 725/124; 725/125

(57) ABSTRACT

A cable-TV-based network transmits data on relatively high-radio frequency signals from a head end toward clients and transmits data on relatively low radio frequency signals from clients to head end. Radio frequency switch assemblies are distributed hierarchically from head end descending toward the clients. Each radio frequency switch assembly splits a descending path into plural branches, and includes switch units for alternatively blocking or passing low frequency signals from ascending the branches. When low frequency noise is detected at the head end, a noise source is located employing a test protocol in which switch units are sequentially set to block upstream signals, with the head end noise detector determining the effect of each switch disposition. Other types of hierarchical networks use analogous diagnostic methods.

### BACKGROUND OF THE INVENTION

The present invention relates to communications networks and, more particularly, to communications networks that use cable-TV infrastructure to access the Internet. A major objective of the invention is to minimize network unavailability when noise interferes with cable communications. Herein, related art labeled “prior art” is admitted prior art, while related art not labeled “prior art” is not admitted prior art.

Cable TV originated as a high-end alternative to over-the-air television broadcasts. Initially an analog medium, cable-TV introduced digital TV for high quality and controlled access at the user end. Set top boxes (STBs) were added to decode the digital signals and provide analog outputs to televisions sets. The role of the STBs expanded to provide some two-way communication, e.g., for ordering pay-per-view TV channels. While the higher frequencies (e.g., above 54 MHz in the United States and other NSTC standard countries, and above 85 MHz in Europe and other PAL standard countries) were reserved for downstream television transmission, the lower “subband” frequencies were available for upstream transmissions.

As demand for high-speed Internet access arose, two-way cable was already in place to provide Internet access to users. However, as the Internet becomes more media rich (voice-over-Internet, video-on-demand, etc.) and more integrated into customer's daily lives, the demand for trouble-free services has been mounting. This demand will only increase, as Internet TV and especially Interactive Internet TV are made available.

Noise can interfere with the functioning of a cable-TV network. Several tools, both handheld and larger, are available for locating noise sources in the field. If the noise source turns out to be at the customer end, the customer's equipment can be disconnected from the network pending repairs. If the noise source is above the taps connected to the customer end, service can be cut to all customers downstream of the noise source. In general, service interruptions due to noise are too invasive and extended to meet customer expectations.

### SUMMARY OF THE INVENTION

The present invention provides for a network with a hierarchical arrangement of signal paths between a head end and client interface devices in which the head end can control switches along the signal paths and analyze the effects of the switching for trouble-shooting purposes. For example, the network can be a cable-network with Internet services and the client interface devices can be cable modems.

The invention can provide for independent control of upstream and downstream signals by a switch. For example, in a cable network, downstream signals can be high frequency and upstream signals can be low frequency. A switch assembly can use diplex filters to split and combine upstream and downstream signals. Switches along a split portion of the signal path can control the upstream and downstream signals independently.

The head end can control a switch assembly either over a signal path controlled by the switch or via another path. In the context of a cable system, the path for command signals from the head end to switch assembly can be the same cable path as that traversed by an upstream signal controlled by the switch assembly. Alternatively, a separate wired or wireless control path from head end to switch assembly can be used.

The invention allows network trouble-shooting and problem isolation from the head end. For example, the source of noise in upstream signals can be located by successively blocking and passing upstream signals at different intermediate network locations. Where the upstream signals are controlled independently of the downstream signals, downstream operation can continue during trouble-shooting of upstream signals. For example, in a cable network, television broadcasts can continue while upstream signals are examined as candidate noise sources. Once a noise source is located, it can be blocked by a switch until a repair or other corrective action can be taken. Thus, in the context of a bidirectional cable network, problem analysis and correction can be automated and be performed without unduly interfering with TV broadcasts.

Basically, the present invention enhances the cable-TV-grade network to a voice and media carrier-grade network. In addition to improving noise handling for cable/Internet networks, the invention provides for better fault handling for traditional cable TV broadcast control, for traditional cable TV quality control and monitoring, and for any return path data transmission, e.g., from set-top boxes. Overall, the invention reduces downtime and reduces refunds to customers for lost service, reduces the maintenance head count, and, thus, provides for a lower network operating cost. These and other features are provided for by the present invention as explained in the text below with reference to the following figures.

### BRIEF DESCRIPTION OF THE DRAWINGS

FIG. 1 is a block diagram of a first cable network in accordance with the present invention.

FIG. 2 is a flow chart of a method of the invention employable in the networks of FIG. 1.

FIG. 3 is a block diagram of a second cable network in accordance with the invention.

FIG. 4 is a block diagram of an RF switch assembly used in the network of FIG. 3.

### DETAILED DESCRIPTION

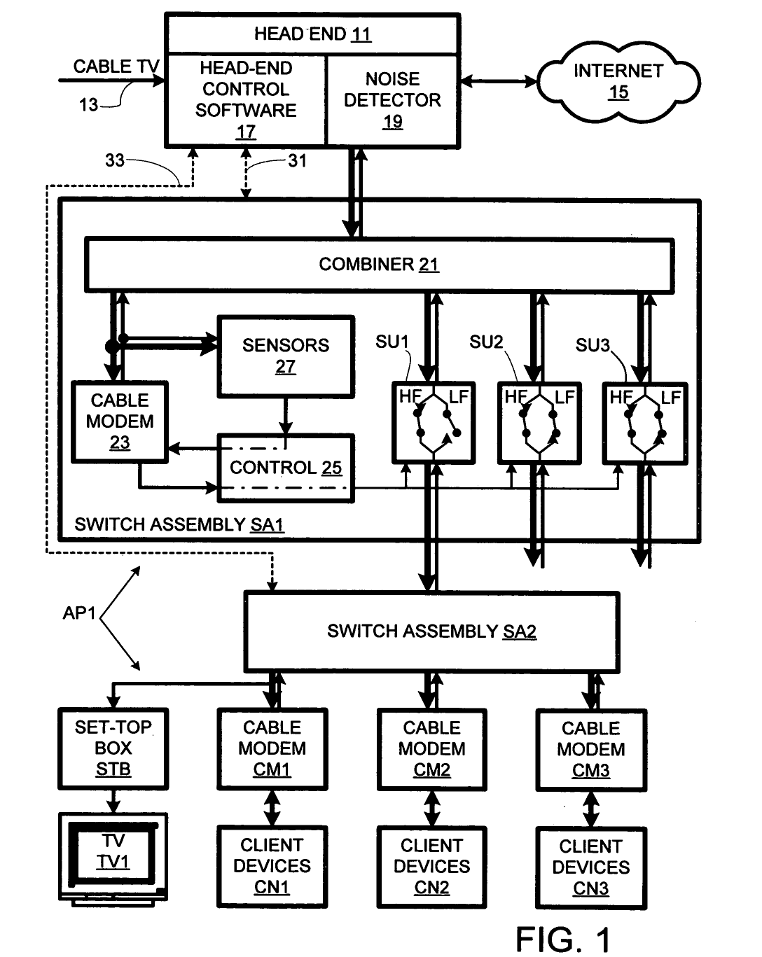

In accordance with the present invention, a cable-TV-based network AP1 comprises a head end 11, radio-frequency (RF) switch assemblies including SA1 and SA2, client (or subscriber) interface devices such as cable modems CM1, CM2, and CM3 and set-top box STB, and client devices including client network devices CN1, CN2, and CN3, and television equipment, e.g., television TV1, as shown in FIG. 1. Network AP1 is structured in a hierarchical manner with head end 11 at the top of the hierarchy and client devices at the bottom. Beyond those shown, other client interface devices and other devices are attached to other switches in the hierarchy.

Head end 11 receives cable TV signals 13 for distribution by network AP1, e.g., to television TV1. In addition, head end 11 serves as the network interface to the Internet 15. Head end 11 includes head-end control software 17 and a noise detector 19. Head end 11 transmits cable-TV and Internet download data down the hierarchy toward client devices at relatively high radio frequencies. Head end 11 receives at relatively low radio frequencies data being uploaded to the Internet 15 from client devices, as well as from set-top boxes.

Network AP1 is designed for the United States NTSC standard. Accordingly, the downstream frequency range is above 54 MHz and typically from 54 Mhz to 860 MHz. The upstream is from 5 to 42 MHz. In the case of a PAL cable network used in Europe and some other areas, the downstream is from 85 Mhz and above typically from 85 Mhz to 860 MHz. The PAL upstream is 5 Mhz to 65 Mhz.

“Televisions”, as used herein, include integrated cable-TV compatible televisions, e.g., TV1, as well as modular systems with cable-TV tuners in set-top boxes and recording devices. Client devices, such as client devices CN1, CN2, and CN3 include computers, broadband routers, Internet appliances, and wireless access pomts and compatible wireless devices. The client devices access network AP1 via cable modems, such as cable modems CM1, CM2 and CM3. Cable modems CM1, CM2, and CM3, receive digital data from client devices CN1, CN2, and CN3, and use it to modulate low radio-frequency carriers; cable modems CM1, CM2, and CM3, also demodulate data on high-frequency carriers and provide the data to client devices CN1, CN2, and CN3. Thus, information moves “down” network AP1 using high frequencies and “up” network AP1 using low frequencies. Cable modems provide analysis of signal parameters as measured by sensors 27.

Network AP1 uses coaxial cable to convey signals, amplifiers to amplify the signals, taps to drop signals to the customers, and several small components. The RF switch assembly SA1 includes amplifiers just after the switches, while switch assembly SA2 includes taps just after the switches. (In other embodiments, switches need not include amplifiers or taps). Each cable modem CM1, CM2, CM3 is coupled to head end 11 by a series pair of similar RF switch assemblies SA1 and SA2. More generally, each cable modem serving a client device in network AP1 is coupled to head end by a series of one, two, or more RF switch assemblies similar to RF switch assembly SA1. The operation of switch assembly SA1 is detailed below; the other RF switch assemblies are similar in structure and function to switch assembly SA1.

Switch assembly SA1 comprises a splitter 21, a cable modem 23, a controller 25, sensors 27, and three switch units SU1, SU2, and SU3. As indicated diagrammatically, each switch unit allows for independent control of high-frequency and low-frequency signals, and thus downstream versus upstream signals. Each switch unit responds to commands from controller 25. Splitter 21 couples switch units SU1-SU3 and cable modem 23 to head end 11. Head end can control switch assemblies SA1 and SA2 by sending commands over the coaxial cables or over wireless links 31 and 33.

In network AP1, low-frequency and high-frequency signals are transmitted in different directions along a common cable. In FIG. 1, the cable is represented by a pair of arrows having opposing directions, with the down arrows thicker than the up arrows to very roughly indicate that the downstream bandwidth is typically greater than the upstream bandwidth. Switch units SU1-SU3 are depicted schematically to indicate that the high frequency and low frequency signals can be independently controlled.

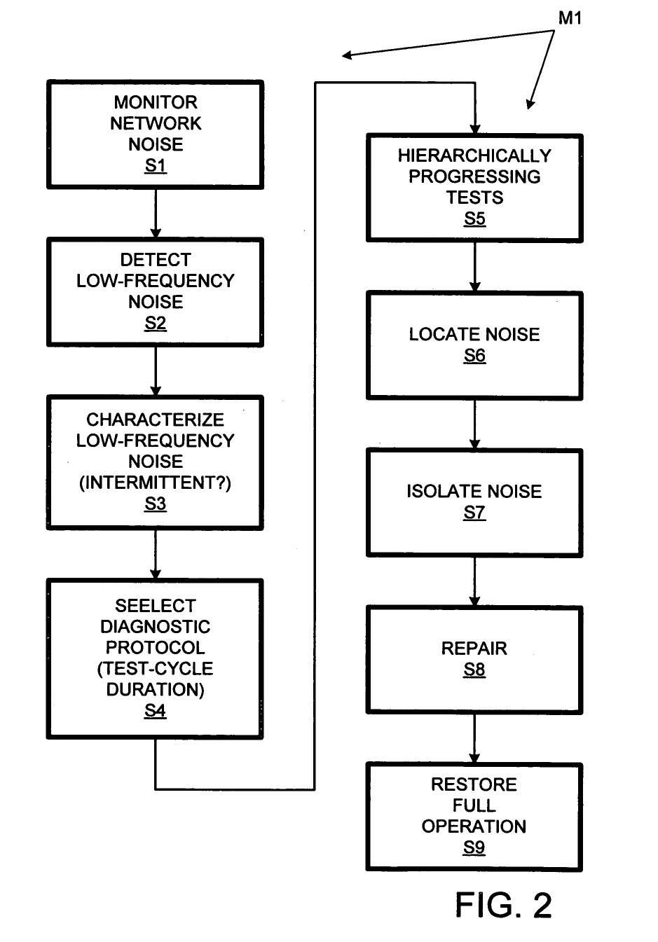

A method M1 of the invention that can be applied to network AP1 and is flow-charted in FIG. 2. During method segment S1, noise detector 19 monitors network AP1 for low-frequency noise. It may also monitor for high-frequency noise and other parameters. For example, attenuation associated with an amplifier can be monitored; changes over time can be used to predict failure. Typically, method segment S1 is implemented whenever network AP1 is operational.

If low-frequency noise does occur on network AP1, noise detector 19 detects it at method segment S2. In alternative embodiments, noise can also be detected near the source by a local cable modem and reported provided the cable modem in the switch is still working. However, noise can force some or all modems to go offline. Head end 11 can detect that modems have gone offline and know about upstream noise in the node but not the exact location. The detected low-frequency noise can then be characterized along one or more dimensions at method segment S3. These dimensions can include time profile, intensity, and spectrum. Spectrum and intensity can provide assist in determining the nature of the noise source. The time profile can distinguish between continuous noise, regularly repeating noise, and irregularly repeating (intermittent) noise.

A diagnostic protocol is selected at method segment S4. To minimize interference with client's use of the network, the diagnostic protocol can test RF switch units in a hierarchically ascending order: the methods starts by disrupting the furthest switches (and users) first and then proceeds up the hierarchy until the switch connected to the fault segment is reached). Alternatively, the testing can descend the hierarchy so that descendants of switch units not subject to noise need not be tested.

To minimize the test duration and interference with network usage, each switch unit can be tested only so long as required for noise detector 19 to detect noise if it were there. If the noise is continuous, the time allotted for detecting noise from a switch unit can be a few seconds or less, depending on actual network characteristics. If the noise is intermittent but regular, then the time must be sufficient for one or two cycles to be detected. If the noise is repeated irregularly, then the time allotted to detection may have to accommodate an upper bound for the expected time between noise instances. Of course, testing of a switch unit can be terminated once noise is detected.

Setting the time window for detecting noise for a switch unit is one way the diagnostic protocol can vary as a function of the noise characterization. In addition, the spectrum and intensity can be used to change the order in which switches are tested so that, at least on average, the diagnosis can be implemented with less interference to clients.

Once the diagnostic protocol is selected it is implemented. Typically, the network, head-end control software (HECS) software 17 sends commands to the cable modems within RF switch assemblies according to the plant control protocol. Most protocols proceed hierarchically downward. This means that from the perspective of a client connected to the head end via a series of RF switch units (and thus, switch assemblies), the more remote switch units are tested first. When a more remote switch unit passes (e.g., turning it off does not eliminate or reduce noise), its descendant RF switch units may not need to be tested. This reduces the time required for the diagnosis and may allow certain segments of the network to continue operating during testing.

The diagnostic protocol is designed to locate the noise source or sources, as indicated at method segment S6, FIG. 2. Once a noise source is located, it can be isolated from the network at method segment S7. For example, the lowest (in the hierarchy) switch that can be left off while eliminating noise is left off. Obviously, client descendants from that switch lose connectivity, but service may continue for other clients on the network.

Once a noise source has been located and, preferably, isolated, it is typically addressed using a repair procedure at method segment S8. This can involve sending repair personnel to the location of the noise source, e.g., to replace a defective switch or cable. If the noise source is located on client premises, a client may be contacted, e.g., by phone, email, or mail. In some cases, the client will have contacted the network owner, who can then instruct the client regarding corrective action. If the client cannot effect the repair, service personnel can be sent to effect the repair. In some cases, a network can be repaired without humans on location. For example, service rerouted around defective equipment or terminated in case of a violation of terms of service.

In some cases, repairs automatically reinstate normal network operation. Operation of non-defective equipment can be reactivated and full network operation resumed at method segment S9. Of course, monitoring method segment S1 continues, and the whole of method M1 can be repeated if noise is detected subsequently.

Many alternative trouble-shooting algorithms are available to locate a noise source. One criterion for selection is minimizing interference with network usage. For example, the selected protocol should tend to minimize the expected average time before a noise source is located and isolated. For example, top-level switch assembly SA1 can be commanded to block low frequency signals through switch unit SU1, then switch unit SU2, then switch unit SU3, then through three pairs of the switch units SU1-SU3, and then through all three switch units at once.

Through each step of this sequence, noise detector 19 monitors low-frequency noise. If at any step in the sequence, noise is no longer detected, the sequence can be halted. Switch units downstream of the switch unit or units that were blocking low frequency signals when the noise detection stopped can then be tested sequentially. If turning off a switch does not eliminate or reduce the noise, it can be assumed initially that the noise source is not downstream of that switch. Therefore, switches downstream of that switch do not need to be tested. However, if the noise source is not located elsewhere, further testing of formerly excluded switches may be required.

If noise continues after all switch units of the top level switch are blocking low frequency signals, the source is determined to be at or above top level switch assembly AS1. Note that if there were more than one top level RF switch assembly, they would all tested sequentially before proceeding down the network hierarchy.

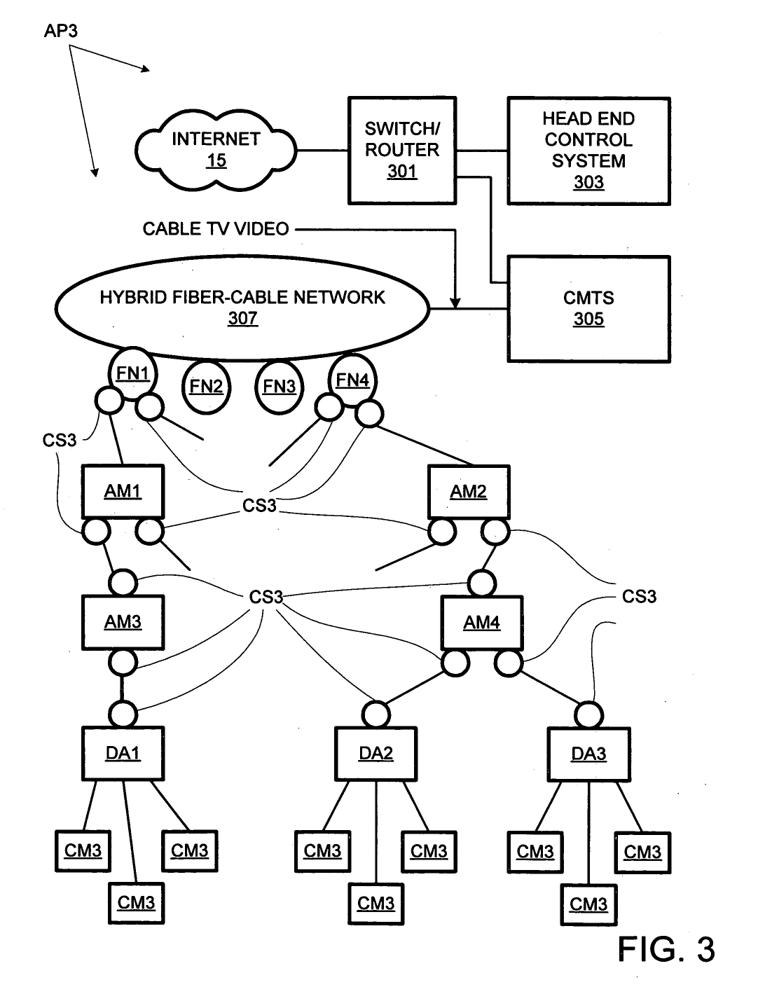

A network AP3 in accordance with the invention employing hybrid fiber/coaxial cabling is shown in FIG. 3. Network AP3 includes a hybrid fiber-cable network 307 with fiber nodes FN1-FN4, which connect to coaxial networks downstream of the fiber nodes. The Internet 15 is coupled to hybrid network 307 via a switch/router 301 and a cable-modem termination system (CMTS) 305. A head end control system (HECS) 303 connects to the cable modem termination system 305 via switch/router 301.

The coaxial networks downstream of the fiber nodes include downwardly branching signal paths with amplifiers AM1-AM4 and drop amplifiers DA1-DA3, the latter coupling to customer cable modems CM3 as shown in FIG. 3. Plant-monitoring control switches are positioned along the signal paths at the downstream ports of the fiber nodes FN1-FN4, at most upstream and downstream ports of the linear amplifiers (with the exception of the ports coupled directly to fiber nodes), and at the upstream ports of the drop amplifiers. The plant monitoring control switches are used for monitoring and trouble-shooting the coaxial portion of network AP3.

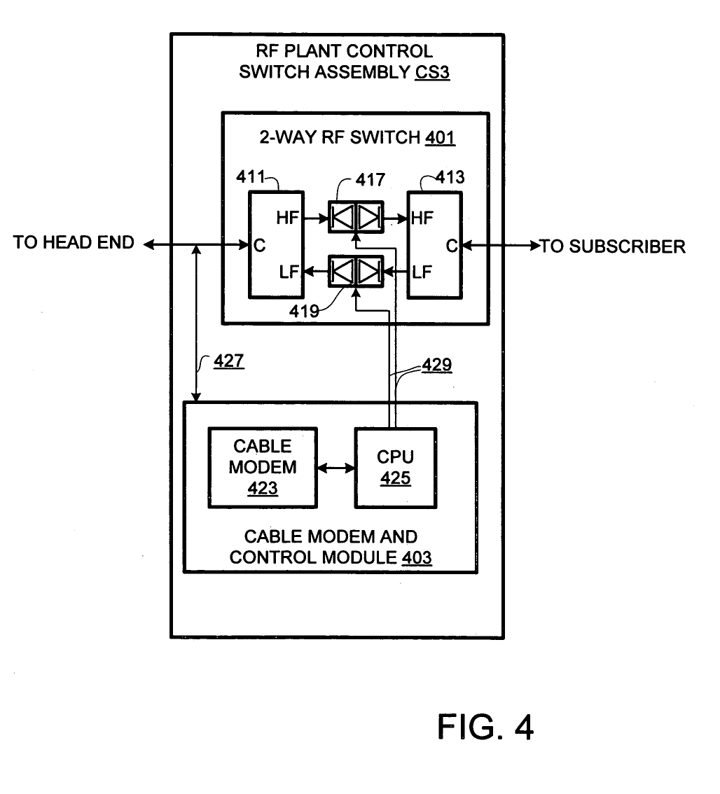

An instance of control switch CS3 is illustrated in greater detail in FIG. 4. Switch CS3 comprising a two-way RF switch 401 and a cable modem and control module 403. Two-way switch 401 includes an upstream diplex filter 411 and a downstream diplex filter 413. These diplex filters cooperate to split a signal path segment into high frequency and low frequency paths that are respectively controlled by switches 417 and 419. The frequency split is selected to separate upstream signals from downstream signals. In other words, for an NTSC system, the split point is between 42 MHz and 54 MHz, while for a PAL system, the split point is between 65 MHz and 85 MHz. Note that two-way RF switch 401 is similar in design to switch units SU1-SU3 in FIG. 1.

Cable modem and control module 403 includes a cable modem 423 and a central-processing unit (CPU) 425. Cable modem 423 includes the sensors required for signal analysis preformed within switch assembly CS3. Head end control system 303 (FIG. 3) can issue switch commands to RF plant control switch assembly CS3. These are received by cable modem 423 over monitoring line 427. Cable modem 423 demodulates the commands and forwards them to CPU 425, which executes the selected commands by asserting voltage levels on control lines 429 to switches 417 and 419.

For example, if the head end control system 303 detects low-frequency noise, it can command a selected RF switch assembly CS3 to block low-frequency signals for some duration, e.g., a minimum duration required for detecting a change in noise level. If the noise source is located entirely downstream of the switch, the result should be a temporary reduction of detected noise at head end 303. By controlling switches CS3 to selectively block and pass low-frequency signals at various points in the network, it is generally possible to locate a noise source.

Noise can be introduced due to the impact of weather, due to plant component failures, and due to problematic connections at the user end, which might be innocent or deliberate. Since cable-TV networks treat high and low frequencies differently, the effects of high- and low-frequency noise can be considered separately. High-frequency noise (e.g., above 54 MHz in an NTSC system) is blocked in the upstream direction and so propagates only in the downstream direction. High-frequency noise can disrupt all downstream services downstream of the noise source (fault) and all 2-way services downstream of the fault. Pure upstream services can continue.

Low-frequency noise, e.g., below 42 MHz, is blocked in the downstream direction and so propagates only in the upstream direction, but impacts entire node as it merges with upstream signals along other paths. Thus, all upstream and two-way services are disrupted, although pure downstream services (e.g., analog and digital cable TV) may continue.

Combined high- and low-frequency noise combines the effects of its components. Noise spreads both upstream and downstream. Upstream and two-way services are disrupted throughout the node (due to low-frequency noises), while downstream services below the node may be impacted by high-frequency noise. However, users that are not downstream of the fault may enjoy continued downstream services.

An RF switch is a device that can turn ON or OFF the flow of RF signals. The RF switch can be used in the cable plant to disconnect or connect two segments of the cable plant. The RF switches in combination with a cable modem and the CPU subsystem running in the module as shown in FIG. 4 can provide a smart RF switch for the monitoring and control of the cable plant. Such a switch for the control of the RF cable plant is called the RF-cable plant monitoring and control switch (RF-PMCS or PMCS).

The two-way RF switch consists of two diplexers to split the signal into HF and LF components at the head end side of the RF switch and combine again on the subscriber side of the RF switch as shown in FIG. 4. This allows for the independent control of the HF and LF components of the signal by the two RF switches on these two paths.

The RF switch on the HF path called the “HF-RF Switch” controls the passage of downstream signal from the head end side to the subscriber side or the downstream signal. The RF switch on the LF path called the LF-RF switch controls the signal going from subscriber side towards the head end side or the upstream signal. The monitoring and control module can turn these two RF switches ON and OFF electronically.

A diplex filter or diplexer is a 3-way passive circuit that combines the signals coming in on the HF side and LF side and passes on to the common port. For the signals coming from the common side it will divide them into HF and LF components and passes them on the appropriate HF/LF ports.

The Low Frequency (LF) in cable TV network is also referred to as subband frequency. It extends from 5 to 42 Mhz in US or NTSC based networks. It is 5 MHz to 65 Mhz in the PAL based networks used predominantly in Europe and other nations. The DOCSIS standard used in these networks is called the DOCSIS or US-DOCSIS or MCNS standard. The High frequency (HF) is referred to as 54 MHz and above in NTSC networks and 65 MHz and above in PAL based networks. The DOCSIS standard used in these PAL based networks is referred to as Euro-DOCSIS. The RF switches will have to account for these frequency differences based on US-DOCSIS/NTSC or Euro-DOCSIS/PAL based networks.

The monitoring and control module or MCM 403 consists of the cable modem and the CPU subsystem. The cable modem RF input is connected on the head end side of the cable plant even before the diplexer circuit to obtain the downstream and upstream signals. Note: If the cable modem in the MCM is connected to the RF cable on the subscriber side, then the modem will not have ability to talk to the head end control system (HECS) 303 when the LF-RF switch in that module is turned off.

The cable modem portion of the MCM monitors the RF signals and data quality at each switch and reports back to the HECS. The data reported back includes DOCSIS based MIB (“management information base) information. In addition, the cable modem talks to the HECS using a standard IP over DOCSIS packets and also extensions of DOCSIS standard to perform some control functions on the PMCS.

The CPU subsystem processes the monitoring data before reporting back to HECS. It processes some of the standard and the DOCSIS extensions to control the PMCS. In addition, the CPU controls the on/off status of the LF-RF and HF-RF switches. In general, it controls the PMCS such that it can participate in plant control procedures as directed by the HECS.

The PMCS is designed to talk to the HECS using the cable modem in the PMCS. The plant monitoring information in a cable network can be collected from several sources. Information can be collected from the cable modems. The plant information is collected from the cable modems in PMCS, outdoor cable modems located on the poles or on the wire, and also from select cable modems located in the user homes. Plant monitoring information can also be collected from power supplies. The cable modems located in the amplifiers and or their power supplies provide information on plant and power supplies. Moreover, plant information can be collected from the CMTS: the plant information or cable modem related information can be collected from the CMTS system for additional details about the plant.

The cable modem in the PMCS is connected to the RF cable plant and is a primary source of plant information. The cable modem in the PMCS can measure the downstream power levels, downstream signal-to-noise (SNR), upstream transmit power level at the modem, micro-reflections and several other parameters that describe not only the signal levels but also the quality of the cable plant as seen at that point. A significant portion of the data is available through the standard and additional cable modem MIBs. Some more information that is not part of the cable modem MIBs is collected and provided. Some portions of the data like the constellation etc. is based on data collected from the cable modems and or from logic next to the cable modem in the PMCS and then processed in the CPU and then sent back to the HECS as MIBs.

The cable modems located in the amplifiers and or their power supplies can also provide valuable information beyond those collected by the cable modem. These modems can also report information on the state of the power supply and any anomalous power usage pointing to potential problems.

In accordance with one aspect of the invention, the CMTS can provide data relating to the upstream as seen from the head end. The upstream SNR, the number of times cable modems lose connections, the number of times the modems power range, the upstream RF keep alive message tracking etc. to measure the quality of the upstream. Application layer communication with the cable modems will also help in estimating quality of the plant by monitoring bit error rates (BER) and other parameters.

The cable modem in the PMCS can analyze the downstream signal and pass on the information to the CPU subsystem to further analyze and then send the information to the HECS. This will allow the HECS to also monitor data that can be obtained from constellation information like, distortion, phase noise etc. Previously, this information was obtained only from the handheld meters carried by technicians when they connect into the cable plant. With this feature the same information can now be obtained remotely and also saved to obtain a history of such data.

The PMCS operation is primarily controlled by the HECS based on instructions using Type-Length-Value (TLV) format. The HECS can send instructions to perform some of the control functions on the PMCS. The control functions include turning ON/OFF the two LF-RF and HF-RF switches either independently or together, and controlling the PMCS such that it can participate in plant control procedures as directed by the HECS.

A plant control procedure is a predetermined order in which the RF switches are turned on and off as the plant is monitored to achieve a certain goal like to identify faults, isolate faults, or turn off segments of the network, etc. The plant control protocol allows the HECS to turn ON/OFF several portions of the network to monitor and trouble shoot the network. Also HECS can turn ON/OFF only the downstream or the only the upstream. This independent control allows for the HECS to monitor the upstream noise problems and or shut down only portions of the network impacted by upstream noise allowing for regular TV broadcasts to pass through.

The PMCS features are described here. The PMCS instructions are based on the TLV model and are summarized below. As mentioned earlier these instructions to the PMCS can be sent as IP packets, as DOCSIS control packets with extensions or over wireless network of any form if the PMCS has a wireless connectivity. Some of the commands for downstream control are represented in the Tables I and II below; the commands for upstream control are analogous.

TABLE I
Write Parameters into PMCS

| S. No. | Parameter | Length | Value | Description |
|---|---|---|---|---|
| 1. | DS RFS DEF | | 0 | Set DS RFS Default to OFF |
| | | | 1 | Set DS RFS Default to ON |
| | | | | Needs special privilege |
| | | | | and/or set HW switch on |
| | | | | PMCS. (DS RFS means |
| | | | | “downstream radio- |
| | | | | frequency switch”) |
| 2 | DS RFS-T-ON | | T sec | 0 = No change |
| | | | | T = x > 0; Turn ON DS-RFS |
| | | | | for x seconds |
| | | | | DS RFS DEF = 1 then no |
| | | | | change |
| 3 | DS RFS-T-ON- | | T sec | Max time for which the |
| | MAX | | | RFS can be turned ON and |
| | | | | will override if x is greater |
| | | | | in above parameter. |
| | | | | Needs special privilege. |
| 4 | DS RFS-T- | | T sec | 0 = No change |
| | OFF | | | T = x > 0; Turn OFF DS-RFS |
| | | | | for x seconds |
| | | | | DS RFS DEF = 0 then no |
| | | | | change |
| 5 | DS RFS-T- | | T sec | Max time for which the |
| | OFF-MAX | | | EFS can be turned OFF and |
| | | | | will override if x is greater |
| | | | | in above parameter. |
| | | | | Needs special privilege. |

TABLE II
Read Parameters from PMCS

| S. No. | Parameter | Length | Value | Description |
|---|---|---|---|---|
| 1. | DS RFS DEF | | 0 or 1 | Read Default setting of |
| | | | | DS-RFS; |
| | | | | 0 = Default is OFF |
| | | | | 1 = Default is ON |
| 2 | Other | | | Similarly all other |
| | parameters | | | parameters give current |
| | | | | values set. |

The RF switches in the downstream and upstream directions can be turned ON or OFF independently. The RF switches can be turned OFF for a preset period of time by the control system. The PMCS can be configured such that the RF switches can be turned OFF for a certain pre-configured maximum time. This helps ensure that the RF network is not down even if the control system is unable to turn the PMCS back to ON position due to any difficulty. If needed, sending another OFF message before the last OFF period expires can extend the OFF time beyond this maximum.

The PMCS can send periodic messages to the HECS that all functions in the system are working fine. A loss of such signal is a warning to the HECS. The PMCS will send all DOCSIS MIBs available by using the standard SNMP MIBs. It uses additional MIBs to send other data collected on a regular basis from cable plant monitoring and PMCS status information. The RF switch handles rigorous reliability metrics of same nature as trunk amplifiers or line amplifiers. The reliability of the network depends on these switches. The RF switches must be able to handle lightning and power surges (for whatever reason).

The RF network maintenance and control algorithms and procedures used to monitor the plant and detect noise are implemented in the HECS. The HECS can be run inside a CMTS or as a separate unit in the head end. If the unit is outside the CMTS then the HECS will rely on the CMTS to generate the Plant Control Protocol packets. Note: The HECS can also operate outside the head end at a remote location but the time delays and reliability of connection from outside network to the head end may be an issue. The HECS performs monitors and analyzes the network for faults, identify and predict faults. It also controls the PMCS and its RF switches using the plant control protocol, and executes automated plant control procedures to detect and isolate faults.

The plant control protocol is based on Type-Length-Value (TLV) format of communication between HECS and PMCS using the programming parameters described in the earlier section to control the RF switches in the PMCS. The plant control protocol can be implemented at the application level on top of TCP/UDP or at the Data link or as modified DOCSIS frames. Some methods of this implementation are described below.

Standard IP can be used over a separate network based on a wireless, telephone or Internet connections independent of the cable network being controlled by the RF switch or PMCS. The plant control protocol is implemented as an application over the TCP/IP connection.

In a standard IP over DOCSIS packets model, if the two-way communication between the CMTS and cable modems is required for operating the plant control protocol. The modems must be registered especially those in the PMCS in order to use this model. Plant control procedures will work as an application over the IP connection as in case 1 above. This model uses standard CMTS and cable modems. TCP/IP or UDP/IP can also be used.

Standard UDP/IP over DOCSIS packets: Even if the network is already disrupted by noise and the two-way communication is broken for traditional TCP/IP over DOCSIS communication. The traditional CMTS cannot talk to the traditional cable modems since the modems would be off line and no longer registered with the CMTS. The CMTS will transmit the UDP/IP packets carrying the Plant control Protocol (PCP) packets in spite of the modems being in unregistered state. The cable modem differs from those of the prior art in that they accept these packets even when the modem is not registered. Being UDP packets, communication works only in downstream direction. Hence the CMTS will have one-way communication with modified CMRs over UDP packets.

Using the protocol extensions of DOCSIS, CMTS sends plant control protocol (PCP) data encapsulated in DOCSIS UDC frames with a dedicated type field chosen from the currently reserved numbers. The cable modems in the PMCS on the receiving end understand these are special packets and executes the commands carried in the payload in the form of TLVs. In all the above four methods the PCP data is carried in a Type-Length-Value (TLV) format. Hence the plant control procedures used to control the RF plant can be based on any of these four methods.

The PMCS is identified using its cable-modem MAC address. All control messages to the PMCS are read by all the PMCS in the network. They will act on the control messages only if the message is addressed to that PMCS device.

This DOCSIS protocol is the lowest level in the network stack compared to the other techniques to carry the PCP. The CMTS and cable modem can exchange the Plant Control Protocol (PCP) data encapsulated in UDC frames. These UDC frames use a special type field chosen from the currently reserved numbers. The type field can be changed to any number that is unused in DOCSIS 1.0/1.1/2.0/3.0 standards.

The UDC DOCSIS frames are transmitted at all times in the downstream direction. These frames are modified such that they do not interfere with normal cable modem operation but are understood by the modified cable modems residing in the PMCS for the control of the cable plant. The modified cable modems in the PMCS understand regular DOCSIS frames and also the modified DOCSIS frames intended for them.

The cable modems in the PMCS on the receiving end understand these are special packets from the CMTS in UDC form and execute the commands carried in the payload in the form of TLVs. The DOCSIS standard extension for the control and management of the PMCS enable the control of the PMCS even when the return path is absent.

The plant control procedures are a series of commands issued by the HECS to control the PMCS distributed in the plant to identify the source of noise and fault in the network and also shut down the downstream and/or upstream transmission to the faulty zone. This helps in isolating the fault zone from disrupting the rest of the network and also identifies the location of problem accurately.

The upstream-RF (or LF-RF) switches and the downstream-RF (HF-RF) switches in the PMCS are controlled using the plant control protocol (PCP) by the HECS to implement the fault isolation as describe in the following sub-sections. The following are only examples and the applications range far beyond those described below.

In the case of high-frequency noise, the signal passes in the downstream direction and not in the return path. Thus, the high-frequency noise can disrupt all services in the downstream direction from the fault location. If the operator wishes to shut down service after this point rather then send a bad signal then a control message is sent to the PMCS before that fault to shut down the downstream RF switch. Unidirectional upstream transmission, if any, can continue. The cable modems after the fault zone will go off line or will have poor connectivity or poor signal reception but barely online. This could be a trigger point to execute the plant protection procedures to isolate the segment.

In the case of low-frequency noise the signal passes in the upstream direction and not in the downstream due to the low frequency filters in downstream direction. This will disrupt all services in the upstream direction from that point and also corrupt all upstream signals coming from users downstream from that location. In short it disrupts the entire node. Hence it is extremely important to reach the PMCS right before the fault and shut down the upstream RF switch to save the rest of the node. The downstream signal is not corrupted and will flow normally. The entire node is impacted and hence it is very complex to identify the fault location. Two of the possible plant control procedures or models are described here as examples.

In model #1, the control starts with the closest PMCS with the shutdown or turn OFF of its upstream-RF switch disconnecting the entire upstream network on the side away from the head end. HECS then checks if the modems before the first PMCS will come online and their noise levels. If there are other noise measurement devices located in the corresponding network segment they can also be polled. If this segment until the first PMCS is clean, then the upstream-RF switch on the second PMCS is opened (OFF) and the upstream-RF switch in the first PMCS is closed (ON). Now the second segment of the network is connected and the rest of the upstream in disconnected. This segment is checked for faults and signal quality. If the modems in the second segment also come one line and RF quality is good then the upstream-RF switch in the second PMCS is closed (ON) and the upstream-RF in the third PMCS will be opened (OFF) for testing the third segment of network in this node.

This process will continue until the faulty segment is connected when the noise will reappear. At this point the PMCS whose upstream-RF was turned on last that caused the noise to reappear will be opened (OFF) so the faulty segment is disconnected. At this point, the location of the faulty segment is clear and the maintenance crew can check this segment first for fault. If the fault is fixed the rest of the upstream segments can be connected to the head end one by one. If the network has several branches then the upstream-RF in one whole branch can be turned ON before activating other branches.

In model #2, the fault isolation process starts from the furthest end from the head end. In this process the upstream-RF is turned OFF in the PMCS starting from the furthest and proceeding towards the head end until the fault is detected. When the faulty segment is disconnected then the good portion of the node closer to the head end will become functional. The faulty segment is now isolated and next to the last PMCS upstream-RF switch that was turned OFF. If the network has several branches then the upstream-RF in one whole branch starting with the furthest must be disconnected before proceeding to the next branch.

The general procedure described above in models #1 and #2 can be combined into the algorithm such that it causes the least disruption. The network or plant topology and the concentration of users will determine the algorithm to implement the fault isolation process. For example the testing can be done for the entire branch first before going to next branch and then test for segments in the branches. The upstream noise solution is similar to the low frequency noise control described above. The downstream noise control is high-frequency noise control is also described above.

Additional features can be added. RF switch hardware extensions can include Trunk and Line amps. RF switches can be located on every port of an amplifier. Wireless technology can be used for collecting data from test points across the network.

Ability to identifying location of users in a cable network, which is based on time slots for the return path, can be extended to any other technology that is based on similar model of networking. Similar models can be applied to broadcast based downstream and time slot based upstream networks like Passive Optical Networks (PON) etc.

Depending on the particular embodiment, the invention provides the following benefits. It allows a noise source to be located within a cable plant. Downstream and upstream noise can be distinguished. Problem segments can be isolated so that service impact is minimized. Quick location of a noise source allows for quick repair. The method allows intermittent noise bursts to be identified. Malicious users are readily identified. Power supplies can be monitored. Power and SNR levels can be associated with a network map to identify potential problems so that they can be addressed before failure.

The following features contribute to the advantages of the invention: 1) the ability to switch upstream and downstream signals independently; 2) the ability to have an RF that reverts to a default connection setting at time out; 3) the ability to use a downstream-based protocol to control RF switches to control ingress; 4) the ability to use automated procedures to quickly detect noise using RF switches; and 5) the provision for remote constellation data collection in real time and derived information from that constellation.

The method described above for locating low-frequency noise sources is designed to minimally disrupt cable television and data services. To further reduce disruption, switches CS3 can operate at attenuation levels between fully on and fully off. For example, if a network continues to function despite the presence of noise, source location can proceed by partially blocking upstream signals so that service is continued. If noise is not reduced, the switch can be restored to fully passing and the downstream service is not interrupted. For another example, switches can be turned on partially to check for noise to determine whether the signal path can be fully restored without bringing down the rest of the network.

The invention provides for many alternative RF switch assemblies, and they need not be all the same. For example, the number of downstream switch units in a switch assembly can range from 1 to many; in other words, different fan-outs are provided for. In the case of one downstream port, branches may be defined by splitting at signal path locations that are distinct from the RF switch assemblies.

The number of hierarchy levels between head end 11 and a television or a client device can vary across the network, but can be roughly equal to the number of RF switch assemblies, the signal path between the head end and the device in issue. In other embodiments, different arrangements, some not strictly hierarchical can be used. Also, different numbers and types of devices can be employed and connected to a network in accordance with the invention.

In the illustrated embodiments, the switches allow high frequency as well as low frequency downstream signals to be passed or blocked. This allows control of downstream data and can allow for diagnosis of some problems associated with high-frequency noise. However, the invention provides for switches that only control low frequencies as well as switches that control both. What constitutes a high or a low frequency simply depends of the frequencies used for carrying downstream and upstream signals in the coaxial cabling of a cable-TV-based network.

In each of the illustrated embodiments, there is a single noise detector located in a head end. The diagnostic methods used with those systems for locating low-noise sources is dependent on this single noise detector. In an alternative cable TV network, the RF switches include noise detectors. Noise detections can be stored and provided upon request to network management software. The advantage is that even intermittent noise sources can be quickly located, whereas intermittent noise sources can delay diagnosis for systems with a single noise detector.

The present invention provides for additional features to the RF switches, to the trouble-shooting algorithms. Moreover, the invention has applicability to other-broadcast based networks and to point-to-point networks. Fixed and mobile wireless can be used to turn off TX of noisy CPE/CM/FW modem/Mobile devices for short periods of time or extended periods of time. These and other variations upon and modifications to the illustrated embodiments are provided for by the present invention, the scope of which is defined in the following claims.

What is claimed is:

1. A network comprising:
a hierarchical arrangement of signal paths;
client interfaces for receiving downstream signals from said signal paths and for transmitting upstream signals through said signal paths, said downstream signals and said upstream signals sharing common signal paths along at least some of said network;
a head end that receives said upstream signals transmitted by said client interfaces and for transmitting said downstream signals to said client interfaces, said head end including a signal analyzer for characterizing received upstream signals; and
plural switch assemblies for selectively passing and blocking respective upstream signals, said head end being communicatively coupled to each of said switch assemblies so that said head end can command each of said plural switch assembly to either pass or block its respective upstream signal.

2. A network as recited in claim 1 wherein each of said switch assemblies selectively passes and blocks an upstream signal while passing a downstream signal.

3. A network as recited in claim 2 wherein each of said switch assemblies includes
a pair of splitters for splitting and recombining upstream and downstream signals so that they are transmitted on separate unidirectional upstream and downstream subpaths of a respective one of said signal paths, and
an upstream switch disposed along said upstream subpath for selectively passing and blocking a respective upstream signal.

4. A network as recited in claim 3 wherein each of said switch assemblies also includes a downstream switch disposed along said downstream subpath for selectively passing and blocking said downstream signal.

5. A network as recited in claim 3 wherein said client interfaces and switch assemblies include cable modems and said splitters are radio-frequency diplex filters.

6. A network as recited in claim 1 wherein said arrangement includes branch points at which downstream signals split into replicas directed to respective sets of client interfaces and at which upstream signals are multiplexed on their way to said head end, at least some of said switch assemblies being between branch points.

7. A network as recited in claim 1 wherein said head end communicates with at least one of said switch assemblies via a signal path traversed by an upstream signal passed by said switch assembly.

8. A network as recited in claim 1 wherein said head end communicates with one of said switch assemblies via a signal path traversed by an upstream signal passed by that switch assembly.

9. A network as recited in claim 8 wherein said head end communicates with one of said switch assemblies via a wireless signal path.

10. A method of managing a hierarchical network in which a head end communicates bi-directionally with plural client interfaces via a hierarchical arrangement of signal paths, said method comprising:
issuing commands from said head end to switch assemblies lying along said signal paths to selectively block and pass respective upstream signals transmitted by said client interfaces; and
analyzing upstream signals received by said head end to locate a source of a problem in said upstream signals.

11. A method as recited in claim 10 wherein said issuing commands involves transmitting command signals to one of said switch assemblies via a path traversed by an upstream signal passed by that switch assembly.

12. A method as recited in claim 10 wherein said issuing commands involves transmitting command signals to one of said switch assemblies by a path other than one traversed by an upstream signal passed by that switch assembly.

13. A method as recited in claim 12 wherein said issuing commands involves transmitting command signals wirelessly to said switch assembly.

14. A method as recited in claim 10 wherein said head end commands said switch assembly to pass a downstream signal while blocking an upstream signal.

15. A method as recited in claim 10 wherein said head end commands said switch assembly to block a downstream signal while passing an upstream signal.

16. A switch assembly comprising:
switch means for selectively blocking and bypassing relatively low radio frequency signals while passing relatively high radio frequency signals in response to received digital command data, said relatively low-radio-frequency carriers and said relatively high-frequency carriers sharing a common signal path;
a cable modem for demodulating a received relatively high-frequency radio signal to yield digital command data;
a controller for applying said digital command data to said switch means.

17. A switch assembly as recited in claim 16 further comprising means for receiving command signals along said common signal path, said switch means selectively blocking and bypassing in response to said command signals.

18. A switch assembly as recited in claim 16 further comprising means for receiving command signals along a path other than said common signal path, said switch means selectively blocking and bypassing in response to said command signals.

19. A cable-TV-based network comprising:
cable modems for modulating digital upload data onto relatively low-radio-frequency carriers and for demodulating digital download data from relatively high-radio-frequency carriers, said relatively low-radio-frequency carriers and said relatively high-frequency carriers sharing a common signal path;
a head end that receives said digital upload data from said cable modems and transmits it to the Internet, and that receives said digital download data from said Internet and transmits it said cable modems, each of said cable modems defining a respective radio-frequency signal path between it and said head end; and
RF switches for selectively blocking and passing said low-radio-frequency carriers at respective network locations, for each of said cable modems, the respective signal path including a series of two or more of said RF switches.

20. A network as recited in claim 19 wherein said head end generates switch control data modulated onto said high-radio-frequency carriers, said RF switches blocking or passing said low-frequency carriers as a function of said switch control data.

21. A switch assembly comprising:
switch means for selectively blocking and bypassing relatively low radio frequency signals while passing relatively high radio frequency signals in response to received digital command data, said relatively low-radio-frequency carriers and said relatively high-frequency carriers sharing a common signal path;
a cable modem for demodulating a received relatively high-frequency radio signal to yield digital command data; and
a controller for applying said digital command data to said switch means.

22. A switch assembly as recited in claim 21 further comprising means for receiving command signals along said common signal path, said switch means selectively blocking and bypassing in response to said command signals.

23. A switch assembly as recited in claim 21 further comprising means for receiving command signals along a path other than said common signal path, said switch means selectively blocking and bypassing in response to said command signals.

24. A method comprising:
receiving command data modulated onto a relatively high-radio-frequency carrier sharing a signal path with relatively low-radio-frequency carriers;
demodulating said relatively high-radio-frequency carrier to obtain digital command data;
applying said digital command data to a switch that selectively blocks and passes said relatively low-radio-frequency carriers while passing said relatively high-radio-frequency carrier so that said command data determines whether said relatively low-radio-frequency carriers are passed then blocked then passed while said relatively high-radio-frequency carrier is passed.
